(19) United States
(12) Patent Application Publication
(10) Pub. No.: US 2010/0099403 A1
(43) Pub. Date: Apr. 22, 2010

(54) USER EQUIPMENT AND ROAMING SETUP METHOD FOR SELECTING PUBLIC LAND MOBILE NETWORK

(75) Inventor: Duck-sung KIM, Incheon-si (KR)

Correspondence Address: H.C. PARK & ASSOCIATES, PLC, 8500 LEESBURG PIKE, SUITE 7500, VIENNA, VA, 22182, US

(73) Assignee: Pantech Co., Ltd., Seoul (KR)

(21) Appl. No.: 12/537,627

(22) Filed: Aug. 7, 2009

(30) Foreign Application Priority Data
Oct. 20, 2008 (KR) 10-2008-0102570

(51) Int. Cl. H04W 8/02

(52) U.S. Cl. 455/432.1

(57) ABSTRACT

A user equipment and a roaming setup method for selecting a public land mobile network for global roaming by receiving a roaming area through a user interface; storing, at a user equipment, identification information of a public land mobile network in the roaming area in preferred public land mobile network identification information of a subscriber identity module; and removing, at the user equipment, last registered public land mobile network identification information from location information of the subscriber identity module. The roaming setup method and user equipment improve a public land mobile network selection procedure to reduce the amount of time and prevent errors during the public land mobile network selection procedure in a roaming area.

### CROSS-REFERENCE TO RELATED APPLICATION

This application claims priority from and the benefit under of Korean Patent Application No. 10-2008-102570, filed on Oct. 20, 2008, which is hereby incorporated by reference for all purposes as if fully set forth herein.

### BACKGROUND OF THE INVENTION

1. Field of the Invention

Exemplary embodiments of the present invention relate to roaming setup, and more particularly, to a user equipment (UE) and a roaming setup method for selecting a public land mobile network (PLMN).

2. Discussion of the Background

To receive mobile communication service abroad, a mobile communication user may use global roaming. For example, an airplane passenger who wants global roaming may set up roaming using his/her UE and then switch the UE to the airplane mode feature or power off the UE. The airplane mode feature prohibits the radio frequency (RF) function of the UE which could affect the airplane and allows other functions.

When the user arrives in a roaming area with the UE, and turns off the airplane feature mode or powers on the UE, the UE first performs a PLMN selection procedure using a location information (LOCI) value of a subscriber identity module (SIM).

Here, the last registered public land mobile network (RPLMN) identification information of a home PLMN before the flight is recorded in the LOCI of the SIM. However, the RPLMN is not an RPLMN of the roaming area, and thus an error occurs in the PLMN selection procedure.

Therefore, the present invention addresses a technique for selecting a PLMN during global roaming.

### SUMMARY OF THE INVENTION

Exemplary embodiments of the present invention provide a roaming setup method and user equipment (UE) that may improve efficiency of the public land mobile network (PLMN) selection procedure to reduce errors during the PLMN selection procedure in a roaming area.

Additional features of the invention will be set forth in the description which follows, and in part will be apparent from the description, or may be learned by practice of the invention.

An exemplary embodiment of the present invention discloses a roaming setup method for selecting a public land mobile network for global roaming by receiving a roaming area through a user interface; storing, at a user equipment, identification information of a public land mobile network in the roaming area in preferred public land mobile network identification information of a subscriber identity module; and removing, at the user equipment, last registered public land mobile network identification information from location information of the subscriber identity module.

An exemplary embodiment of the present invention also discloses a roaming setup method for selecting a public land mobile network for global roaming by receiving a roaming area through a user interface; and storing, at the user equipment, identification information of a public land mobile network in the roaming area in location information of a subscriber identity module.

An exemplary embodiment of the present invention also discloses a user equipment having an area input unit to provide a user interface to select a roaming area, and to receive a roaming area through the user interface; a service provider searcher to search for identification information of a public land mobile network in the roaming area; a service provider storage to store the public land mobile network identification information retrieved by the service provider searcher in preferred public land mobile network identification information of a subscriber identity module; and a location information remover to remove identification information of a last registered public land mobile network from location information of the subscriber identity module.

An exemplary embodiment of the present invention also discloses a user equipment having an area input unit to provide a user interface to select a roaming area, and to receive a roaming area through the user interface; a service provider searcher to search for identification information of a public land mobile network in the roaming area; and a location information storage to store the public land mobile network identification information retrieved by the service provider searcher in the location information of a subscriber identity module.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a flowchart illustrating a roaming setup method for a public land mobile network (PLMN) selection procedure for global roaming according to an exemplary embodiment of the present invention.

FIG. 2 is a flowchart illustrating a PLMN selection procedure in a roaming area during global roaming setup according to FIG. 1.

FIG. 3 is a flowchart illustrating a roaming setup method for a PLMN selection procedure for global roaming according to another exemplary embodiment of the present invention.

FIG. 4 is a flowchart illustrating a PLMN selection procedure in a roaming area during global roaming setup according to FIG. 3.

FIG. 5 is a block diagram of user equipment (UE) to perform a PLMN selection procedure for global roaming according to another exemplary embodiment of the present invention.

FIG. 6 is a block diagram of UE for a PLMN selection procedure for global roaming according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

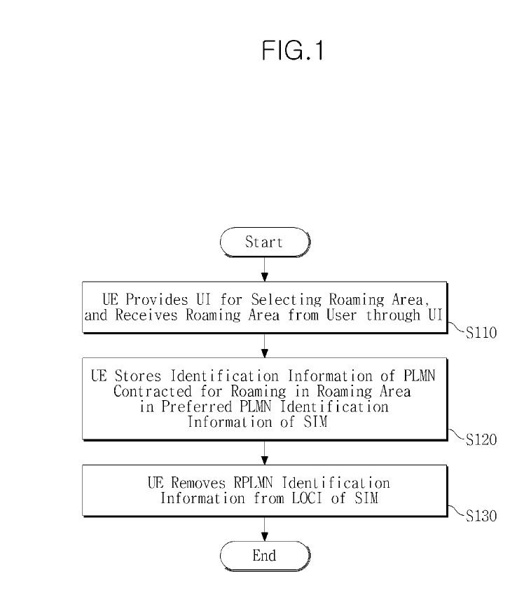

FIG. 1 is a flowchart illustrating a roaming setup method for a public land mobile network (PLMN) selection procedure for global roaming according to an exemplary embodiment. As illustrated in the drawing, according to a roaming setup request from a user, the user equipment (UE) provides a user interface (UI) for selecting a roaming area and receives a roaming area from the user through the UI S110.

When the roaming area is received in operation S110, the UE stores identification information of a PLMN contracted for roaming in the roaming area in preferred PLMN identification information of a subscriber identify module (SIM) S120.

Here, if one or more PLMNs are contracted for roaming in the roaming area, identification information of one or more of the PLMNs contracted for roaming may be stored in preferred PLMN identification information of the SIM.

When the identification information of a PLMN contracted for roaming in the roaming area is stored in the preferred PLMN identification information of the SIM in operation S120, the UE removes the last registered public land mobile network (RPLMN) identification information from the location information (LOCI) of the SIM S130.

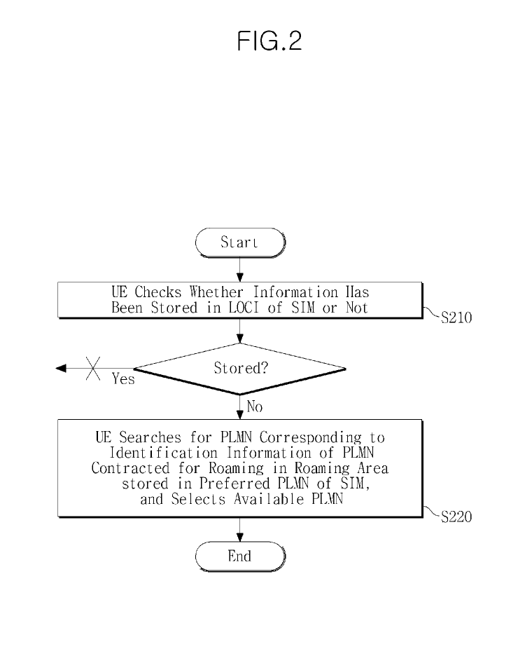

By using this method, the UE removes the RPLMN identification information stored in the LOCI of the SIM during user setup of global roaming. A PLMN selection procedure in a roaming area when global roaming is set according to the exemplary embodiment of FIG. 1 will be described with reference to FIG. 2. FIG. 2 is a flowchart illustrating a PLMN selection procedure in a roaming area.

When the user arrives in the roaming area and turns off the airplane mode feature of the UE or powers on the UE, the UE checks whether information is stored in the LOCI of the SIM S210.

According to conventional art as described above, when a UE is switched to the airplane mode feature or powered off, the RPLMN identification information is recorded in the LOCI of the SIM. However, the RPLMN belongs to a home PLMN (HPLMN) and cannot be accessed if the user has arrived in a different country where the HPLMN is not available.

When the user turns off the airplane mode feature of the UE or powers on the UE in the roaming area, a search is executed for the RPLMN identification information stored in the LOCI of the SIM, and a PLMN selection procedure is performed.

But since the RPLMN does not belong to a PLMN contracted for the roaming area, and instead belongs to the HPLMN, an error occurs.

During global roaming setup according to the exemplary embodiment illustrated in FIG. 1, the RPLMN identification information stored in the LOCI of the SIM is removed. Thus, no search is executed for the RPLMN identification information in the LOCI of the SIM in operation S210, and no error occurs while the PLMN selection procedure is performed in the roaming area.

When a search is executed and in operation S210 and checks that no RPLMN identification is stored in the LOCI of the SIM, the UE searches for a PLMN corresponding to the identification information of a PLMN contracted for roaming in the roaming area stored in the preferred PLMN of the SIM according to the exemplary embodiment illustrated in FIG. 1, and selects an available PLMN S220, such that the user can use global roaming service.

Therefore, it is possible to decrease wasted time and reduce unnecessary battery consumption while the UE selects a PLMN in a roaming area.

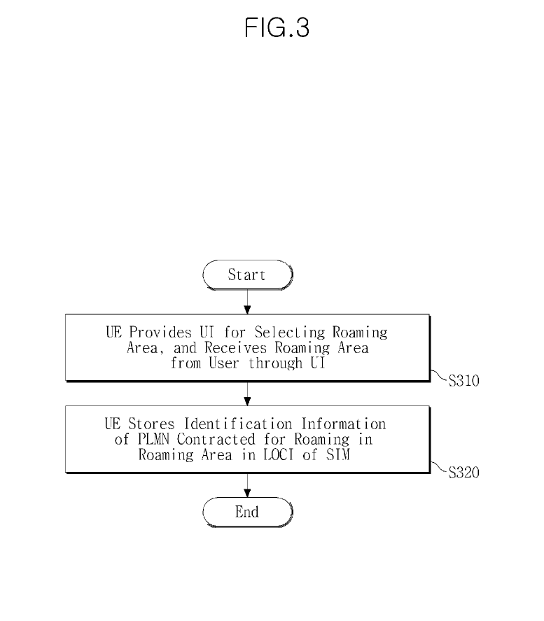

FIG. 3 is a flowchart illustrating a roaming setup method for a PLMN selection procedure for global roaming according to another exemplary embodiment. As illustrated in the drawing, UE provides a UI for selecting a roaming area according to a roaming setup request from a user, and receives a roaming area from the user through the UI S310.

When the roaming area is received in operation S310, the UE stores identification information of a PLMN contracted for roaming in the roaming area in the LOCI of a SIM S320. Here, the identification information of a PLMN contracted for roaming may include a mobile country code (MCC) and a mobile network code (MNC).

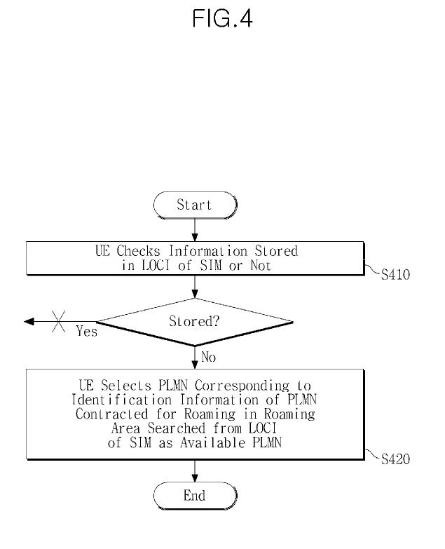

In this way, the UE records identification information of a PLMN contracted for roaming in the roaming area in the LOCI of the SIM during user setup of global roaming. A PLMN selection procedure in a roaming area when global roaming is set according to the exemplary embodiment of FIG. 3 will be described with reference to FIG. 4. FIG. 4 is a flowchart illustrating a PLMN selection procedure in a roaming area.

When the user arrives in the roaming area and turns off the airplane mode of the UE or powers on the UE, the UE checks information stored in the LOCI of the SIM S410.

According to the conventional art as described above, when the UE is switched to the airplane mode or powered off, RPLMN identification information is recorded in the LOCI of the SIM. Here, the RPLMN belongs to an HPLMN.

When the user turns off the airplane mode of the UE or powers on the UE in the roaming area, the RPLMN identification information stored in the LOCI of the SIM is searched for, and a PLMN selection procedure is performed.

But since the RPLMN does not belong to a PLMN contracted for the roaming area and instead belongs to the HPLMN, an error occurs.

During global roaming setup according to the exemplary embodiment illustrated in FIG. 3, the identification information of a PLMN contracted for roaming in the roaming area is stored in the LOCI of the SIM, and thus is checked in the LOCI of the SIM in operation S410. Therefore, an error may be avoided while this PLMN selection procedure is performed in the roaming area.

When a PLMN corresponding to the identification information of a PLMN contracted for roaming in the roaming area is checked in the LOCI of the SIM in operation S410, the UE selects the PLMN as an available PLMN S420, such that the user can use global roaming service.

Therefore, it is possible to decrease wasted time and reduce unnecessary battery consumption while the UE selects a PLMN in the roaming area.

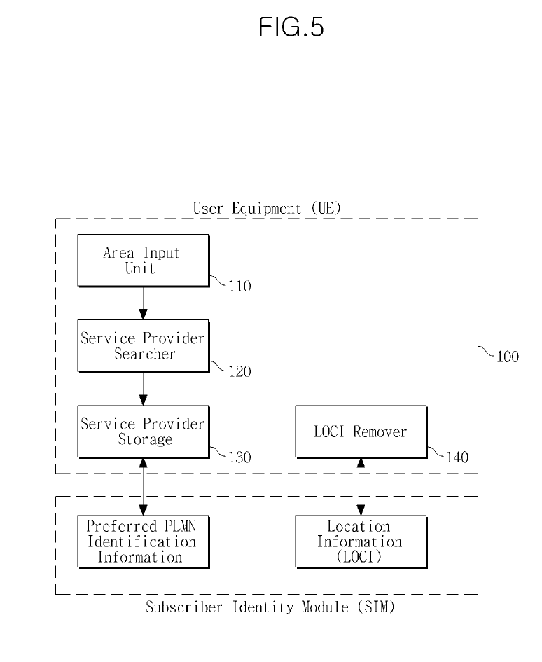

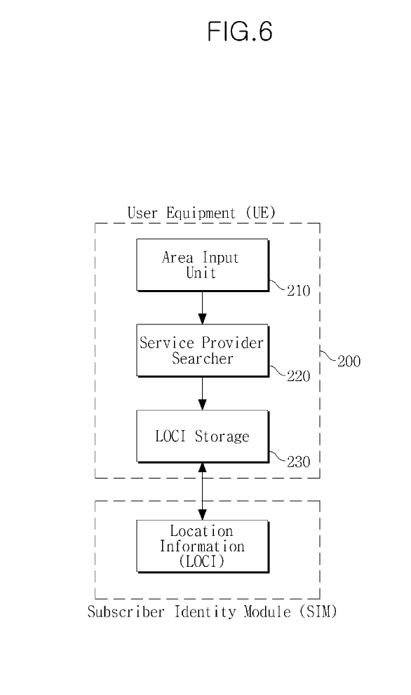

A UE to perform the roaming setup method for a PLMN selection procedure for global roaming will be described with reference to FIG. 5 and FIG. 6. FIG. 5 is a block diagram of a UE to perform a PLMN selection procedure for global roaming according to an exemplary embodiment.

As illustrated in the drawing, UE 100 for selecting a PLMN for global roaming according to an exemplary embodiment includes an area input unit 110, a service provider searcher 120, a service provider storage 130, and a LOCI remover 140. Here, the area input unit 110, the service provider searcher 120, the service provider storage 130, and the LOCI remover 140 may exist in the form of software stored on a storage medium in the UE 100 to perform the global roaming setup executed in the UE 100.

The area input unit 110 provides a UI for selecting a roaming area according to a roaming setup request from a user, and receives roaming area information from the user through the UI.

The roaming setup request from a user may be made by selecting a roaming setup menu or when the UE is switched to the airplane mode.

When a roaming area is input through the area input unit 110, the service provider searcher 120 searches for identification information of a PLMN contracted for roaming in the roaming area.

For example, a list of PLMNs contracted for roaming in each area may be provided when the UE is manufactured, or in advance, by a HPLMN. When a roaming area is input through the area input unit 110, the service provider searcher 120 may search the list of PLMNs contracted for roaming for identification information of a PLMN contracted for roaming in the roaming area.

The service provider storage 130 stores the PLMN identification information retrieved by the service provider searcher 120 in preferred PLMN information of a SIM.

Here, when identification information for one or more PLMNs is retrieved by the service provider searcher 120, the service provider storage 130 may store the identification information of the one or more PLMNs in preferred PLMN identification information of the SIM.

The LOCI remover 140 removes RPLMN identification information from the LOCI of the SIM when the PLMN identification information is stored by the service provider storage 130.

Thus, during user setup of global roaming for selecting a PLMN for global roaming according to an exemplary embodiment, the UE 100 removes RPLMN identification information stored in the LOCI of the SIM, which may result in improved efficiency while selecting a PLMN in a roaming area, reducing wasted time, and reducing unnecessary battery consumption, as illustrated in FIG. 2.

FIG. 6 is a block diagram of UE for selecting a PLMN for global roaming according to another exemplary embodiment. As illustrated in FIG. 6, the UE 200 includes an area input unit 210, a service provider searcher 220, and a LOCI storage 230. Here, the area input unit 210, the service provider searcher 220, and the LOCI storage 230 may exist in the form of software stored on a storage medium in the UE 200 to perform the global roaming setup executed in the UE 200.

The area input unit 210 provides a UI for selecting a roaming area according to a roaming setup request from a user, and receives a roaming area from the user through the UI.

The roaming setup request from a user may be made by selecting a roaming setup menu or when the UE is switched to the airplane mode.

When a roaming area is input through the area input unit 210, the service provider searcher 220 searches for identification information of a PLMN contracted for roaming in the area.

For example, a list of PLMNs contracted for roaming in each area may be provided when the UE is manufactured, or in advance, by an HPLMN. When a roaming area is input through the area input unit 210, the service provider searcher 220 may search the list of PLMNs contracted for roaming in each area for identification information of a PLMN contracted for roaming in the roaming area.

The LOCI storage 230 stores the PLMN identification information retrieved by the service provider searcher 220 in the LOCI of an SIM. Here, the identification information of a PLMN contracted for roaming may include a MCC and a MNC.

Thus, the UE 200 selects a PLMN for global roaming according to an exemplary embodiment by recording identification information of a PLMN contracted for roaming in a roaming area in the LOCI of the SIM, which may result in improved efficiency, decreasing the amount of time while selecting a PLMN in a roaming area, and reducing unnecessary battery consumption, as illustrated in FIG. 4.

As is apparent from the above description, the exemplary embodiments select a PLMN to reduce errors during the PLMN selection procedure in a roaming area. Thus, it is possible to reduce wasted time and reduce unnecessary battery consumption.

The exemplary embodiments can be industrially used and applied in any global roaming technology area and device.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A roaming setup method for selecting a public land mobile network for global roaming, comprising:
receiving a roaming area through a user interface;
storing, at a user equipment, identification information of a public land mobile network in the roaming area in preferred public land mobile network identification information of a subscriber identity module; and
removing, at the user equipment, last registered public land mobile network identification information from location information of the subscriber identity module.

2. The roaming setup method of claim 1, wherein storing the identification information comprises storing identification information of a plurality of public land mobile networks in the preferred public land mobile network identification information of the subscriber identity module.

3. A roaming setup method for selecting a public land mobile network for global roaming, comprising:
receiving a roaming area through a user interface; and
storing, at the user equipment, identification information of a public land mobile network in the roaming area in location information of a subscriber identity module.

4. The roaming setup method of claim 3, wherein the identification information of the public land mobile network contracted for roaming includes a mobile country code and a mobile network code.

5. A user equipment, comprising:
an area input unit to provide a user interface to select a roaming area, and to receive a roaming area through the user interface;
a service provider searcher to search for identification information of a public land mobile network in the roaming area;
a service provider storage to store the public land mobile network identification information retrieved by the service provider searcher in preferred public land mobile network identification information of a subscriber identity module; and
a location information remover to remove identification information of a last registered public land mobile network from location information of the subscriber identity module.

6. The user equipment of claim 5, wherein identification information of a plurality of public land mobile networks is retrieved by the service provider searcher, and the service provider storage stores the identification information of the public land mobile networks in the preferred public land mobile network identification information of the subscriber identity module.

7. A user equipment, comprising:
an area input unit to provide a user interface to select a roaming area, and to receive a roaming area through the user interface;
a service provider searcher to search for identification information of a public land mobile network in the roaming area; and
a location information storage to store the public land mobile network identification information retrieved by the service provider searcher in the location information of a subscriber identity module.

8. The user equipment of claim 7, wherein the identification information of the public land mobile network contracted for roaming includes a mobile country code and a mobile network code.
